(19) United States
(12) Patent Application Publication
(10) Pub. No.: US 2016/0180683 A1
(43) Pub. Date: Jun. 23, 2016

(54) Swimming Pool Safety Device

(71) Applicant: Andries Petrus Cronje FOURIE, Parkview (ZA)

(72) Inventor: Andries Petrus Cronje FOURIE, Parkview (ZA)

(21) Appl. No.: 15/055,950

(22) Filed: Feb. 29, 2016

Related U.S. Application Data
(63) Continuation-in-part of application No. PCT/IB2014/064143, filed on Aug. 29, 2014.

(30) Foreign Application Priority Data
Aug. 29, 2013 (ZA) 201306504

(51) Int. Cl. G08B 21/08; E04H 4/06

(52) U.S. Cl. CPC G08B 21/084; E04H 4/06

(57) ABSTRACT

The invention relates to a water safety device and more particularly, to a safety device for swimming pools or fish ponds. There is provided a device for monitoring a body of water comprising a first pressure sensor for measuring a base pressure level within a first reference cavity in the device, a second pressure sensor for measuring a water pressure level being exerted on the second pressure sensor by the body of water, computing means for calculating differential pressure between the base pressure level and the water pressure level, and alerting means in communication with the device for generating an alert when the differential pressure level and water pressure level is increased due to an elevation in the water pressure level when a person enters the body of water.

### INTRODUCTION AND BACKGROUND

This invention relates to a water safety device and more particularly, but not exclusively, to a safety device for swimming pools.

Drowning is listed as one of the top global causes of unnatural death amongst children, and is only trumped by road traffic deaths as accidental cause of death.

A known method of ensuring safety around a swimming pool comprises installation of a safety net above the pool surface. A disadvantage of this method is that safety nets are expensive and must be removed every time the pool is being used. A further disadvantage of safety nets is that closing the pool with a net can be both tedious and time consuming. For this reason, people often do not replace the net after swimming, thereby leaving the pool exposed and unsafe.

Devices that measure surface waves and sub-surface waves via pressure sensors have also been described in the art. When a child or other object falls into a swimming pool, sensors detect changes in the sub-surface pressure of the water, or wave movement created by the child or object falling into the pool. Once the change in sub-surface pressure or the wave movement created by the child or object falling into the pool and splashing in the water exceed a predetermined level, and alarm signal is activated to alert a parent or guardian. Although these type of devices have significantly decreased the incidence of drowning, especially in children, certain disadvantages remain which causes a decrease in effectiveness of these devices.

A first disadvantage associated with these sub-surface pressure sensors is a delay between the moment when a child or object falls into the pool, and when the alarm is activated. This often leads to parents or guardians not being alerted in time, and by the time they reach the pool, the child has already been submerged for an undesired period, with the resulting oxygen shortage leading to brain damage or death.

A further disadvantage of known sub-surface alarms is the incidence of false alarms due to weather interference or when a person enters the pool to swim. Some devices have been adapted so that it may be deactivated when people are swimming or when the pool is being cleaned or serviced, and then manually reactivated afterwards. Accordingly, an even further disadvantage with these systems is that it is easy to forget to reactivate the device, causing the pool to be unsafe during the period in which the device is inactive.

### Objects of the Invention

Objects of the current invention are accordingly to provide a water safety device with which the problem of drowning of especially children in large bodies of water such as swimming pools could be alleviated, and to at least partially overcome the difficulties associated with known swimming pool safety devices.

### SUMMARY OF THE INVENTION

According to a first aspect of the invention there is provided a device for monitoring a body of water comprising:
a first pressure sensor for measuring a base pressure within a first reference cavity in the device;
a second pressure sensor for measuring a water pressure being exerted on the second pressure sensor by the body of water;
computing means for calculating differential pressure between the base pressure and the water pressure; and
alerting means in communication with the device for generating an alert when the differential pressure is increased due to an elevation in the water pressure when a person enters the body of water.

Further according to the invention, the base pressure may be equalised at set intervals.

Still further according to the invention, the device may be provided with a second reference cavity for measuring a second base pressure whilst the base pressure in the first reference cavity is being equalised.

Yet further according to the invention, the device may be calibrated to generate an alert when an increase in differential pressure falls within a set range. The set range may be pre-programmed relative to a volume of the body of water and weight of a person entering the body of water.

Even further according to the invention, the device may automatically deactivate when the increase in differential pressure falls outside of the set range. Furthermore, the device may automatically reactivate when the differential pressure level decreases.

Even further according to the invention, the alerting means may be connected to a remote alarm. The remote alarm may generate an audio-visual alarm.

Still further according to the invention, the device may be linked with a weather sensor. The weather sensor may comprise wind and rain sensors.

Yet further according to the invention, the device may be linked with an inflatable device located within the body of water, wherein upon generation of the alert generated by the alerting means, the inflatable device automatically inflates and rises to the surface of the body of water to assist a person in distress.

The body of water may be a swimming pool. Alternatively, the body of water may be a fish pond.

### BRIEF DESCRIPTION OF THE ACCOMPANYING DIAGRAM

The invention will now be described further by way of a non-limiting example with reference to the accompanying drawing wherein:

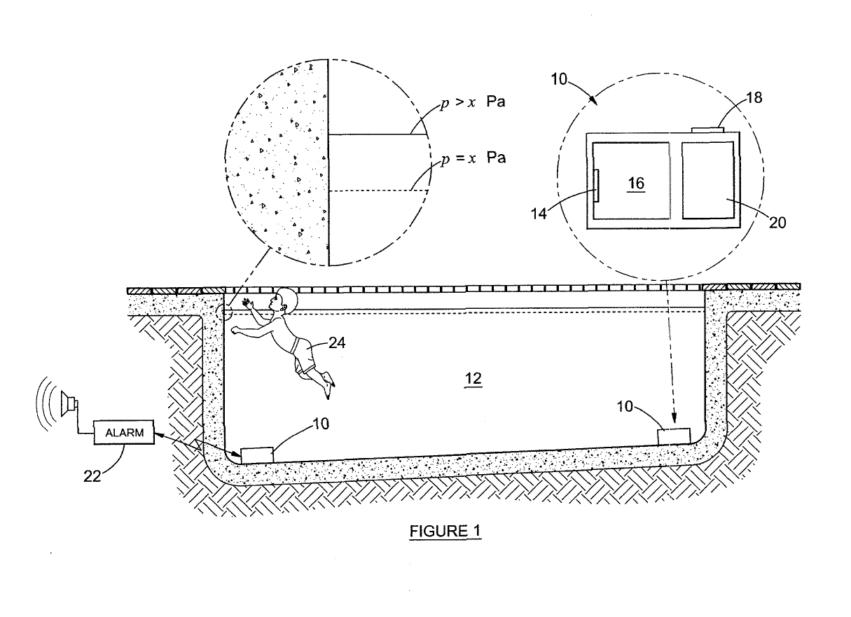

FIG. 1: is a representation of a swimming pool equipped with the device according to the invention.

### DESCRIPTION OF A PREFERRED EMBODIMENT OF THE INVENTION

Referring to FIG. 1, a water safety device according to a first preferred embodiment of the invention is generally designated by reference numeral 10.

The device 10 for monitoring a swimming pool 12 comprises a first pressure sensor 14 for measuring a base pressure within a reference cavity 16 in the device 10, and a second pressure sensor 18 for measuring level of the water pressure being exerted on the second pressure sensor 18 by the water in the swimming pool 12. Computing means 20 calculates the differential pressure between the base pressure and the water pressure, and alerting means 22 generates an alert when the differential pressure is increased due to an elevation in the water pressure when a child 24 falls into or enters the swimming pool 12.

Reference cavity 16 is equalised every 5 or 10 seconds, and the base pressure in the reference cavity 16 is then compared to the actual water pressure as measured by the second pressure sensor 18. The computing means 20 then detects the absolute pressure difference between the base pressure and the water pressure.

In an alternative version of the first embodiment, a second reference cavity is provided (not shown), which second reference cavity equalises at different intervals than reference cavity 16 to avoid missing a child entering the water during the equalisation of the reference cavity 16.

Accordingly, when a child falls into or enters the swimming pool, the water level is increased relative to the weight of the child. This change in water level increases the pressure exercised on pressure sensor 18, which increase in pressure causes the differential pressure between the water pressure in the pool 12 as measured by the pressure sensor 18, and the pressure in the reference cavity 16 measured by pressure sensor 14, to increase. As illustrated, the pressure of the water in the pool (p) as measured by pressure sensor 18 is at a constant level (xPascal or xPa) when there is no person present in the pool. When a child falls into the pool, the pressure measured by pressure sensor 18 is suddenly increased by the displacement of the water relative to the weight of the child, which causes the pressure of the water in the pool as measured by pressure sensor 18 to be elevated above the previous level (p).

The computing means is calibrated to activate the alerting means to generate an alert when an increase in differential pressure falls within a set range, which is pre-programmed relative to the volume of the swimming pool and the weight of a child entering the swimming pool. The weight of the child entering the pool will increase the water pressure exerted on the sensor placed at the bottom of the pool to a certain degree, dependant on the volume of the pool. It is therefore foreseen that the computing means will be calibrated to detect when a child weighing within a weight range of 5 kilograms and 20 kilograms enters the pool, upon which the alerting means will be activated to generate an alert. Children weighing less than 5 kilograms are not mobile to the degree that they will be able to move towards the pool and fall in by themselves, and children over 20 kilograms are most often able to swim or to call for help. Due to the calibration of the weight range, the device will not be triggered by objects like toys or garden matter entering the pool. The device will further not be triggered when objects or persons exceeding 20 kilograms in weight enter the pool, and the device therefore does not have to be de-activated during normal swimming activities. The lower and upper limits of the weight range can be adjusted by the user according to personal preferences, and in doing so the device can also be calibrated to generate an alert when pets like dogs or cats accidentally fall into the swimming pool.

In an alternative version of the first embodiment, the device automatically deactivates when the increase in differential pressure falls outside of the perimeters of the set range, and then automatically reactivates when the differential pressure decreases to the previous value, when the person that entered the pool and caused the differential pressure to increase, leaves the pool.

The device 10 is in wireless communication with a remote alerting means 22 that can be placed in or around the house. When a child enters the pool, an audible alarm is generated to alert a parent, guardian or other responsible person of the child entering the pool. In doing so, the child can be removed from the pool relatively shortly after entering the pool, thereby significantly reducing the incidence of brain damage or death due to the child being submerged and not being able to breathe. The alerting means 22 also emits a visual alarm such as a flashing light to increase the effectiveness of the alarm and ensure that the alarm reaches a person that could assist.

It is also foreseen that the device could be provided with weather sensors (not shown), to assist with minimising false alarms caused by inclement weather (wind, rain etc), and by relatively sudden increases in pool volume due to excessive rain and hailstorms.

It is further foreseen that the device could be linked with an inflatable device located within the body of water, wherein upon generation of the alert when the differential pressure rises, the inflatable device automatically inflates and rises to the surface of the body of water to assist a person or child in distress.

The main advantage of the device according to the invention over the prior art is the detection of bulk increase in water level by means of one or more pressure sensors located as deep as possible in a pool which naturally averages out movements in the water above. The device utilises changes in differential pressure rather to determine the mass of a body suddenly entering the water, and by coupling it with the calibration of a weight range, the device is able to relatively accurately signal an alert when a child enters the swimming pool, whilst also minimising false alarms.

The measurement of differential pressure rather than absolute pressure has the advantage of a relative increase in sensitivity of the device over prior art devices. The comparison of differential pressure between the pressure in the reference cavity with actual water pressure causes the device to be relatively more sensitive to actual increases in water pressure due to a child entering the water, whilst being able to eliminate false alarms brought about by movement of surface water due to weather circumstances, and especially wind and rain, and also movement of water brought about by pool cleaning equipment.

It is further foreseen that by equipping a pool with a plurality of sensors that are capable of communicating with each other in a system (not shown), detection of bulk changes in water levels may be sensed more accurately and at an earlier stage after a child has entered the pool, due to an averaging of pressures measured by the plurality of pressure sensors. By earlier detection, critical time is saved in prevention of a child drowning or a child suffering permanent damage due to prolonged unwanted submersion. The increased sensitivity of the device according to the invention also overcomes the disadvantage of a delayed alarm notification that is often experienced with known devices.

The invention is also set apart from the prior art by being able to detect a sudden pressure increase and sounding an alarm. The device will accordingly not be triggered when the pressure is gradually increased by refilling of the pool or by rain, hail, snow or other factors increasing the water level over a prolonged period. This allows false alarms due to rain and filling of the pool to be limited, and the disadvantage of frequent false alarms with known devices is accordingly overcome.

The functionality of the invention that allows calibration of a weight range within which the alarm will be triggered, whilst not being triggered when a person or object weighing outside of the weight range enters the pool, overcomes the disadvantage of having to de-activate the device when normal swimming or pool cleaning activities take place, and having to re-activate the device when these activities are concluded.

According to a second embodiment of the invention (not illustrated), one or more water pressure sensors are provided to measure the water pressure exerted on the water pressure sensors. The water pressure sensors are located remote from the surface of the water, and preferably as close as possible to the bottom of the body of water, in order to minimize the effect of movements on the surface of the body of water. It is foreseen that a plurality of sensors can be placed at different depths or positions within the body of water in order to average out movements caused by waves, while ensuring accurate measurements of the water pressure.

Further according to the second embodiment of the device, computing means are provided in communication with the water pressure sensors.

The computing means is configured to determine two parameters: Firstly, an increase in average water level is determined by monitoring a total increase in water pressure in proximity with the water pressure sensors, while secondly, a rate of increase of water pressure, or a time-based increase in average water level, can be determined.

Further to the second embodiment of the invention, alerting means in the form of a remote alarm is provided in communication with the computing means, which may provide an audio-visual alarm to indicate or alert a person that someone has entered the water.

A threshold is provided for each of the two parameters determined by the computing means. In order for the alerting means to be activated, the measured parameter must fall within the predetermined threshold. Upper and lower water pressure limits can be introduced to provide a range that will activate the alarm. The water pressure limits will correspond to the weight of a person entering the water, and may take the physical properties of the pool (area and volume) into consideration. Further to this, upper and lower limits may be provided for the rate of increase of water pressure to ensure that the gradual addition of weight to the body of water, in the form of rain, snow, hail or any other form of addition of weight to the body of water does not trigger the alarm, even when the predetermined weight has been added to the water.

The introduction of thresholds to the two computed parameters as mentioned above ensures that the number of false alarms generated is limited. It also allows an adult, garden matter, toys or other objects having weights falling outside of the predetermined threshold to enter the water without triggering the alarm, even while the device is active. A gradual increase of average water level caused by rain or other weather conditions, or by topping up the water level by means of a garden hose, will also not trigger the alarm.

The above is made possible by the computing means determining time-based increases in average water level, as measured by the water pressure sensors.

The device may additionally be linked to weather sensors such as wind sensors or rain sensors, which might further decrease the occurrence of false alarms.

The device may also be linked to an inflatable device that may automatically be inflated when the device is triggered, to provide assistance to a person in distress.

A person skilled in the art will be able to appreciate the applicability of the current invention in both swimming pools and fish ponds.

The disadvantages associated with safety nets being expensive, cumbersome and tedious to install and remove are accordingly also at least partially overcome, due to the device according to both embodiments of the invention not having to be physically removed before and replaced after each swimming session to maintain the safety of the pool.

It is accordingly asserted that the disadvantages associated with known swimming pool safety devices could be alleviated with the device according to the invention.

It will be appreciated that in terms of the invention, variations in details are possible without departing from the scope of the appended claims.

1. A device for monitoring a body of water comprising:
one or more water pressure sensors located within the body of water and remote from the surface in use, for measuring the water pressure exerted on the one or more water pressure sensors;
computing means for determining a time-based increase in average water level by monitoring a corresponding increase in the water pressure as measured by the one or more water pressure sensors over time; and
alerting means in communication with the device for generating an alarm when the increase in water level falls within a predetermined threshold.

2. A device for monitoring a body of water according to claim 1, wherein the one or more water pressure sensors are located proximate to the bottom of the body of water.

3. A device for monitoring a body of water according to claim 1, wherein the predetermined threshold is the increase in water level corresponding to a weight range of a person entering the body of water within a time range.

4. A device for monitoring a body of water according to claim 1, wherein the device is linked with a weather sensor.

5. A device for monitoring a body of water according to claim 4, wherein the weather sensor is selected from the group consisting of wind sensors and rain sensors.

6. A device for monitoring a body of water according to claim 1, wherein the device is linked with an inflatable device located within the body of water, wherein upon generation of the alert generated by the alerting means, the inflatable device automatically inflates and rises to the surface of the body of water to assist a person in distress.

7. A device for monitoring a body of water according to claim 1, wherein the body of water is selected from the group consisting of swimming pools and fish ponds.

8. A device for monitoring a body of water comprising:
one or more base pressure sensors located in the body of water in use, for measuring a base pressure within one or more reference cavities in the device;
one or more water pressure sensors located within the body of water in use, for measuring the water pressure exerted on the one or more water pressure sensors;
computing means for determining a time-based increase in average water level by monitoring a differential pressure between the base pressure and the water pressure; and
alerting means in communication with the device for generating an alert when the differential pressure is increased due to an elevation in the water pressure when a person enters the body of water.

9. A device for monitoring a body of water according to claim 8, wherein two water pressure sensors are provided, both being located within the body of water and remote from the surface, and wherein the water pressure is an average calculated from the readings of the two water pressure sensors.

10. A device for monitoring a body of water according to claim 8, wherein the base pressure is equalised at set intervals.

11. A device for monitoring a body of water according to claim 8, wherein the device is provided with a second reference cavity for measuring a second base pressure whilst the base pressure in the first reference cavity is being equalised.

12. A device for monitoring a body of water according to claim 8, wherein the device is calibrated to generate an alert when an increase in differential pressure falls within a set range.

13. A device for monitoring a body of water according to claim 12, wherein the set range is pre-programmed relative to a volume of the body of water and weight of a person entering the body of water.
